(19) United States
(12) Patent Application Publication
(10) Pub. No.: US 2002/0087644 A1
(43) Pub. Date: Jul. 4, 2002

(54) Internet portal URL link through an e-mail prompt for the delivery of solicited and unsolicited information based on the original information requested

(76) Inventors: Edward J. Zylka, Blue Bell, PA (US); Donald W. Merino, Portland, OR (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(21) Appl. No.: 09/753,544

(22) Filed: Jan. 3, 2001

(51) Int. Cl. G06F 15/16

(52) U.S. Cl. 709/206; 709/217

(57) ABSTRACT

An information system for selectively providing information in response to a request from a user comprises memory, for storing several databases of information; a search unit, for analyzing the user request and retrieving information related to said request from the memory to generate a first output information signal and for analyzing the first output information signal and retrieving information related to the first output information signal from the memory to generate a second output information signal. The system also includes a webpage unit for receiving the first and second output information signals and selectively displaying said signals on a webpage. The system notifies the user via an output unit, which generates an e-mail to the user which includes the address of said webpage.

### BACKGROUND

The present invention relates generally to an internet portal URL link through an e-mail prompt. More specifically this invention allows for the delivery of solicited and unsolicited information based on an original solicitation of information.

Access to the internet has provided individuals with the ability to send information to others without the use of traditional mail, faxes or telephones. This information can be provided using a number of different methods. One method is through the use of individual websites, where the user is able to place any information they desire for others to see. Another method is through the use of e-mail. With e-mail, users have the ability to send information to many known users on the internet. The information that is sent through e-mail may not have been solicited by the receiver, but it permits the sender to provide information to a large audience.

A third method in which information is accessed using the internet is with a URL address. In this method, the user sends a URL address to the receiver. The URL address is a pointer to a webpage which contains the information that the user would like to provide to the receiver. The receiver then clicks on the URL and is sent to the webpage where the information is located and displayed.

This third method has allowed more users to provide specific services to other individuals. The services include the ability of users to provide specific information to those that request it. An individual is able to go to a user's website and click on a URL that has the specific requested information.

The ability to provide an individual with the information that they have solicited is an important aspect of business advertising. But equally important to providing solicited information, is the ability to provide unsolicited information which is related to the solicited information. This allows the user to provide a value added service to an individual. As it relates to businesses, this ability provides the company with another avenue for advertising products that may be related to product information that was solicited by the customer. It also allows a business to offer other businesses an opportunity to advertise their services or products to a customer who has solicited specific information.

Accordingly, there is a need for a system which provides for the delivery of solicited and unsolicited information based on an original information request.

### SUMMARY

The present invention is an information system which provides solicited and unsolicited information to consumers. The system comprises a host interface, which provides services for each member of the system, and a plurality of private information databases, where the solicited information is stored, an enhanced information database, which stores unsolicited information, and an output unit, for generating a display for the consumer. The system searches the solicited information databases and outputs the results of the first search to the output unit and the enhanced database, where a second search is conducted for related information. The result of the second search is also output to the output unit which creates a webpage comprising the found solicited information and additional unsolicited information for display to the consumer.

### BRIEF DESCRIPTION OF THE DRAWINGS

FIG. 1A is a block diagram of the information system in accordance with the present invention.

FIG. 1B is a flow diagram of the information system of FIG. 1A.

FIG. 2A is a block diagram of an alternative embodiment of the present invention.

FIG. 2B is a flow diagram of the information system in accordance with the alternative embodiment of the present invention shown in FIG. 2A.

FIG. 3 is a block diagram of a second alternative embodiment of the present invention.

FIGS. 4A and 4B are flow diagrams of the information system in accordance with the second alternative embodiment of the present invention shown in FIG. 3.

FIG. 5 is an illustration of the host site interface in accordance with the preferred embodiment of the present invention.

FIG. 6 is an illustration of the member site in accordance with the third alternative embodiment of the present invention.

### DETAILED DESCRIPTION OF THE PREFERRED EMBODIMENTS

The preferred embodiment will be described with reference to the drawing figures where like numerals represent like elements throughout.

The information distribution system 5 is incorporated as part of a limited access website. This website provides individual members with private databases in which information can be stored. The purpose and type of information that is stored by each individual member is solely their discretion. For example, Member A may store their home recipes in order to allow specific individuals to request a recipe and view it on their computer. Another member, Member B, may store their reviews of all movies that they have seen and cd's that they have heard in order to provide individuals with their opinion.

Access to the members' information maybe limited solely to the member. Any updating or editing of the information may be conducted by the member. A member may also permit individuals to access limited portions of their information. Since access to a member's information can be controlled by the member, consumers must correspond directly with a member independent of the information distribution system 5. The member then must request that the solicited information be sent to the consumer.

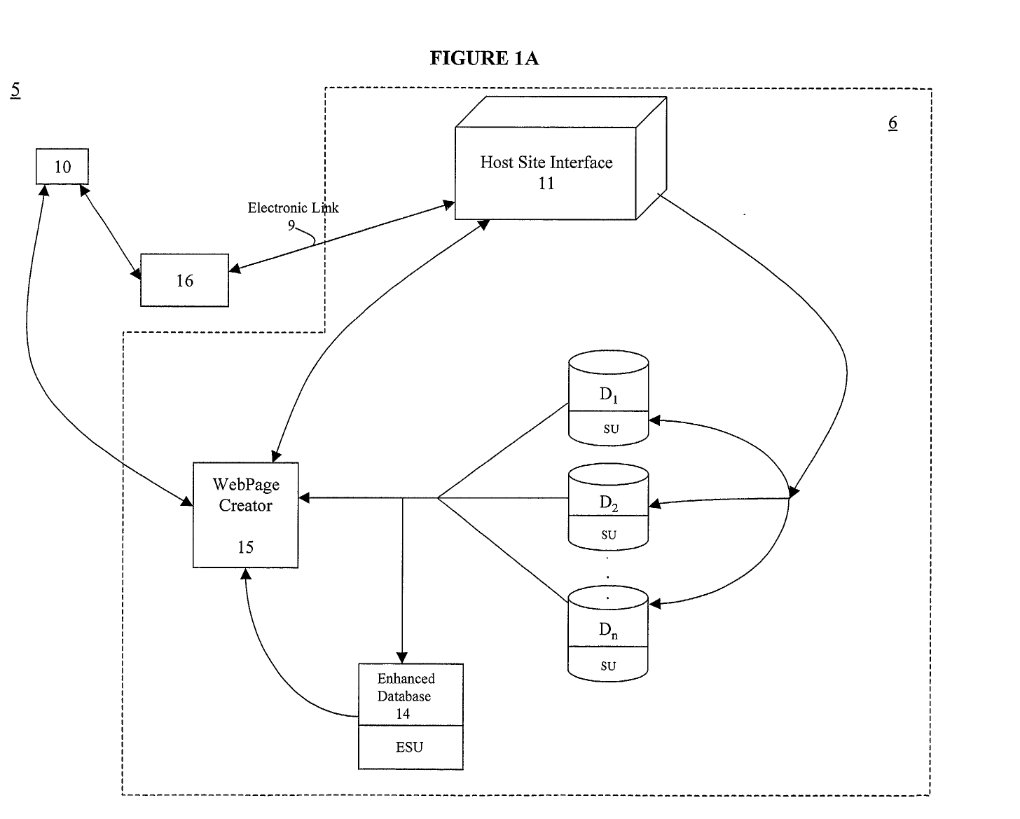

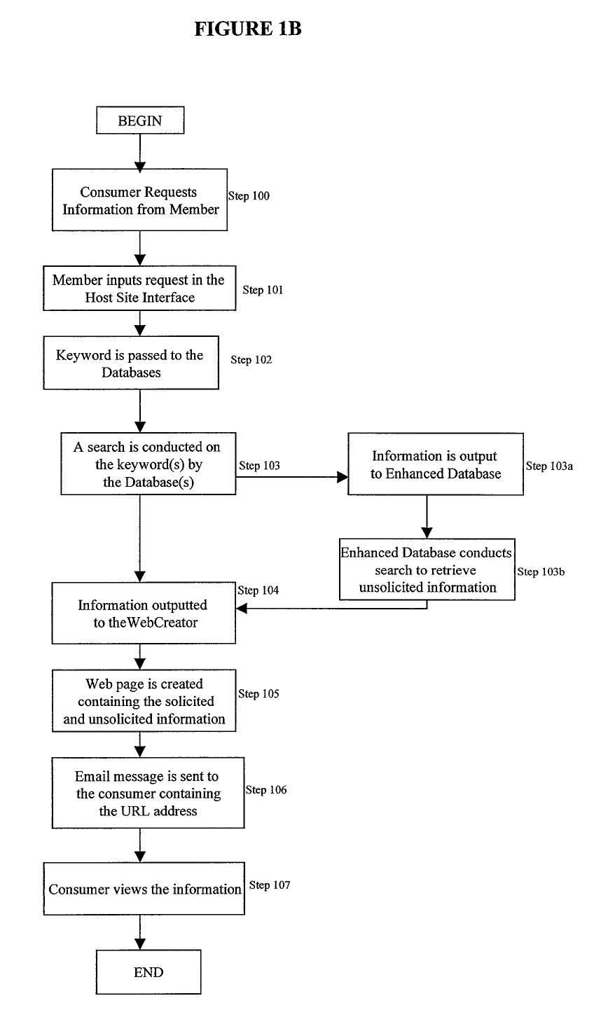

Referring to FIG. 1A, the information distribution system 5 comprises a host site 6 which is used by a plurality of members 16 and a plurality of consumers 10. The plurality of consumers 10 request information from the plurality of members 16. Although the information distribution system 5 of the present invention may be utilized with a plurality of consumers 10 and a plurality of members 16, for simplicity of explanation the system 5 will be described with reference to a single consumer 10 and a single member 16. Upon receipt of a request from a consumer 10, the member 16 interacts with the host site 6. The host site 6 is the means by which a member 16 manipulates their information and distributes private information to a consumer 10. The host site 6 comprises a host site interface 11, a plurality of databases D₁, D₂ . . . Dₙ, an enhanced database 14 and a webpage creator unit 15.

The host site interface 11 provides for communicating between a member 16 and the host site 6. The host site interface 11 is coupled to a member 16 through an electronic link 9, such as the internet. Alternatively, the electronic link 9 may be a CATV network, phone network or wireless network which provides a point-to-point, or point-to-multipoint communication interface. This host site interface 11 provides a member 16 with the ability to execute remote commands with the host site 6 including, but not limited to, updating their information, inputting search and distribution requests for solicited and unsolicited information, and changing access codes to maintain database integrity.

When a member 16 receives a request from a consumer 10 regarding certain information that is contained in one or more of the databases D₁, D₂ . . . Dₙ, the member 16 uses the host site interface 11 to conduct a search and distribute the information to the intended consumer 10. The member 16 enters the host site interface 11 using a password which is known only to the member 16. This password gives the member 16 unlimited access to their private information stored in one or more of the databases D₁, D₂, . . . Dₙ. The password also allows the member 16 to request that the host site 6 conduct a search of the databases D₁, D₂ . . . Dₙ and distribute the solicited and unsolicited information to the consumer 10, (hereinafter referred to as a “search and distribute” operation).

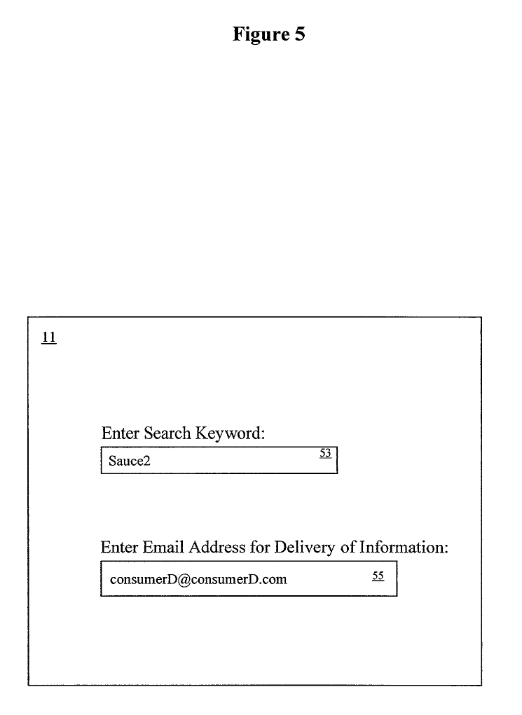

Referring to FIG. 5, the member 16 requests the host site 6 to conduct the search and distribute operation of the databases D₁, D₂ . . . Dₙ by entering a keyword in the keyword field 53 provided on the host site interface 11, and an e-mail address in the e-mail address field 55 of the consumer 10 for whom the information is to be viewed. For purposes of describing the preferred embodiment, use of a keyword search is disclosed. However, as should be known to those skilled in the art, numerous methods other than keyword searching exist for conducting a search of a database in order to generate specific output. For example, the member 16 may be able to view all of the information in their database and select the pertinent information to be output to the consumer 10.

The keyword, known only to the member 16, relates to specific information within the member's 16 stored data. As an example, Member A has stored a number of recipes and Consumer D e-mails a request to Member A to view their recipe for spaghetti sauce. Knowing that their recipe for spaghetti sauce is called sauce2, Member A enters sauce2 into the keyword field 53 provided on the host site interface 11, and the e-mail address for Consumer D in the e-mail address field 55. As those skilled in the art should know, the keyword entered by the member 16 does not have to be equivalent to the title given to the information stored in the member's 16 private database. The keyword could be any word found within the solicited information; the member 16 knowing that the less specific the keyword is, the more information that may be distributed to and accessed by the consumer 10.

Returning to FIG. 1A, upon the member 16 entering the request for the host site 6 to conduct a search and distribute operation, the input key word is forwarded to the plurality of databases D₁, D₂ . . . Dₙ. The plurality of databases D₁, D₂ . . . Dₙ, store the private information of the members 16. Each database D₁, D₂ . . . Dₙ includes an associated search unit SU. The search unit SU receives the keyword from the host site interface 11 and conducts a keyword search within its associated database. For example, database D₁ may contain numerous recipes, substitute ingredients, measurements, etc. The search unit SU for database D₁ utilizes the keywords by matching the keyword with information stored in the database D₁, and retrieving the information associated with the keyword. The retrieved solicited information is then sent to the webpage creator unit 15 to be displayed for the user 10, as well as to the enhanced database 14 to obtain related unsolicited information. Although the system has been described herein as including an SU for each of databases D₁, D₂ . . . Dₙ, a single SU may be used for the plurality of databases D₁, D₂ . . . Dₙ or a single SU may be used with a single large database including the information of all members.

The enhanced database 14 includes unsolicited information and an associated enhanced search unit ESU. Although the enhanced database 14 is similar in function to that of the other databases D₁, D₂ . . . Dₙ disclosed above, the enhanced database 14 contains additional stored information relating to the information stored in the plurality of solicited information databases D₁, D₂ . . . Dₙ. The enhanced search unit ESU receives the retrieved information from the database(s) D₁, D₂ . . . Dₙ and conducts a search for any information that is related to, or can be associated with, this retrieved information, (i.e. matching information). The resulting unsolicited information from the enhanced database 14 is then output to the webpage creator unit 15 to be included with the solicited information to be provided to the consumer 10.

The information that is contained in the enhanced database 14 may come from the member 16, an authorized advertiser, another member, or a database of information provided by the host site 6 which contains advertisers that have signed up with the host site 6 (not shown). All information output by the enhanced database 14 relates to the consumer's 10 request.

An example which illustrates the function of the enhanced database 14 assumes that the requested information is a recipe for spaghetti sauce. The enhanced search unit ESU receives this information and searches the enhanced database 14 for items relating to the spaghetti sauce recipe, (i.e., advertisers for tomato sauce, wines that compliment Italian dishes, desserts, substitute ingredients, etc. . . . ). Information from the databases D₁, D₂ . . . Dₙ and the enhanced database 14 is sent to the webpage creator unit 15 to be displayed for the consumer 10.

The webpage creator unit 15 is coupled to the enhanced database 14, the solicited information databases D₁, D₂ . . . Dₙ, and the host site interface 11. This webpage creator unit 15 produces a personal webpage including the consumer's 10 solicited information and any unsolicited information found by the enhanced database 14. As those skilled in the art should know, there are numerous methods which can be used to create a webpage from a given set of inputs and a discussion of such methods is outside the scope of the present invention.

Once the webpage is created, the webpage creator unit 15 signals the host site interface 11 to send an e-mail message to the consumer 10 to inform them that their solicited information may be found on a webpage designed especially for them. Included in this e-mail message is a URL address which the consumer 10 is able to select, and an access code that allows the consumer 10 to access the webpage. This access code provides the member with additional security from an uninvited consumer 10 attempting to access their private information. Upon selection of this URL and inputting of the access code, the webpage is displayed for the consumer 10.

The process that the information distribution system 5 uses to provide tailored information to consumers 10 in accordance with the preferred embodiment of the present invention is shown in FIG. 1B. The consumer 10 contacts the member 16 and requests information regarding a specific topic (step 100). The member 16 types in the requested information keyword on the host site interface 11 (step 101), where it is passed to the databases D₁, D₂ . . . Dₙ to perform a search on the keyword (step 102). Each database D₁, D₂ . . . Dₙ receives the keyword, conducts a search on the stored information (step 103) and outputs any information found to the webpage creator unit 15 (step 104) and the enhanced database 14 (step 103a). Upon receipt of the retrieved information, the enhanced database 14 conducts a search of its information database (step 104b) for any related information. Any unsolicited information that is found is then sent to the webpage creator unit 15 (step 104). The webpage creator unit 15 then creates a webpage containing the solicited information as well as the unsolicited information from the database(s) D₁, D₂ . . . Dₙ and the enhanced database 14 (step 105). An e-mail message is sent to the consumer 10 containing a URL (step 106) that allows the consumer 10 to select and view the information provided (step 107).

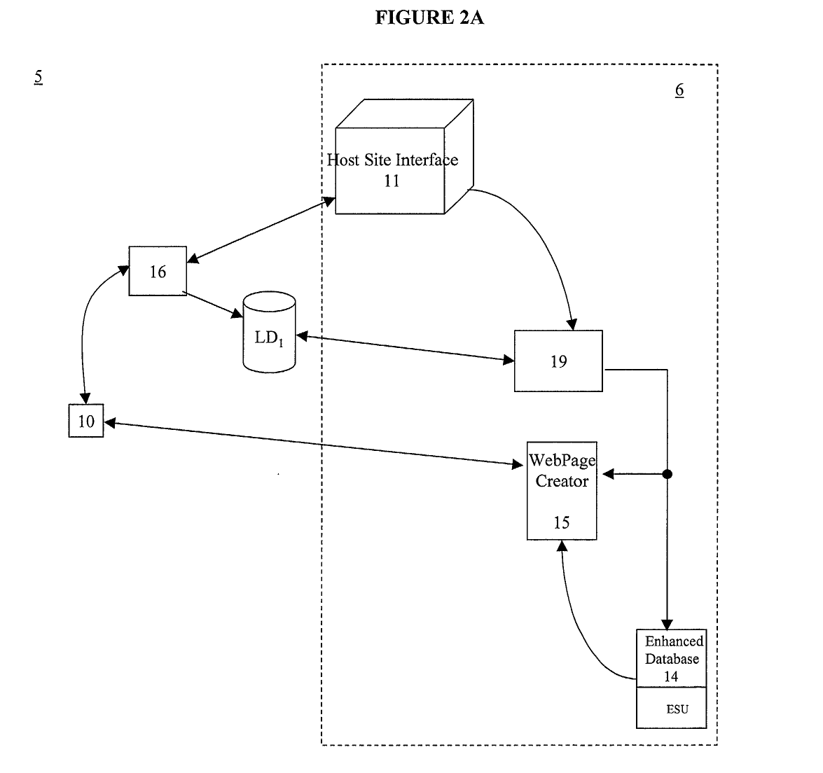

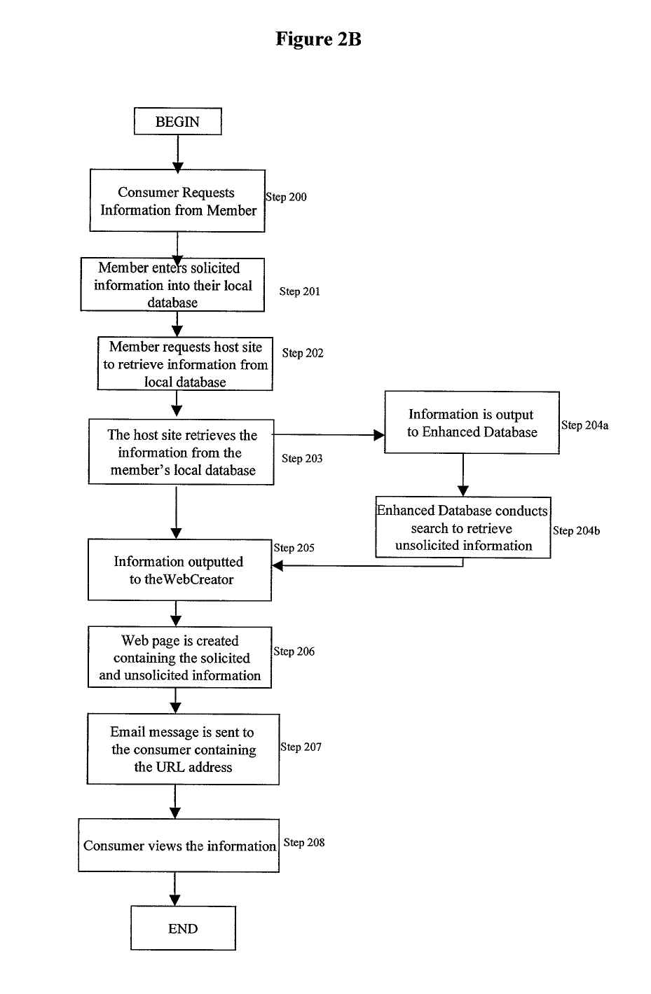

As an alternative embodiment, the host site 6 provides a member 16 with the ability to link their stored information to the host site interface 11 through a host/member link unit 19. The host/member link unit 19, shown in FIG. 2A, provides the host site interface 11 with the ability to extract private information from the member's 16 local database LD₁ that is located remotely from the host site 6. This host/member link unit 19 is coupled to the host site interface 11 and the local database LD₁. Upon the member 16 receiving a request for information from a consumer 10, the member 16 may request that the host site 6 obtain the solicited information from the member's local database LD₁. Since the member 16 maintains the local database LD₁ independent of the host site 6, it is the responsibility of the member 16 to update the local database LD₁. The member 16 must search their stored information and transfer the requested information to the local database LD₁, if it is not already located in the local database LD₁.

The task of requesting the host site 6 to obtain the solicited information from the member's 16 local database LD₁ and distribute the information to the consumer 10 is accomplished similar to the aforementioned method of the member 16 requesting the host site 6 to conduct a search and distribute operation in the preferred embodiment. The difference, though, is the member 16 only requests the host site 6 to perform a retrieve and distribute operation of the information contained in the member's local database LD₁. A retrieve and distribute operation simply requests the host site 6 to retrieve the solicited information from the local database LD, and distribute the information to the consumer 10. These tasks are shown in the flow diagram in FIG. 2B.

Referring to FIG. 2B, the member 16 receives a request from a consumer 10 (step 200). The member 16 then places the requested information in their local database LD₁ (step 201) and requests the host site 6 to retrieve the information from the local database LD₁ (step 202). The host site 6 then retrieves the information from the local database LD₁ through the host/member link unit 19 (step 203) and delivers it to the webpage creator unit 15 (step 205) and the enhanced database 14 (step 204A). The remaining tasks are the same as those disclosed in the preferred embodiment above. Those having skill in the art should realize that there are numerous ways in which this link service can be provided to members, such as with a standard telephone connection or over a CATV communication system. A discussion of the type of link is outside the scope of the present invention.

A second alternative embodiment of the present invention utilizes a peer-to-peer connection between the consumer 10 and any member 16. A consumer 10 would simply be able to go to the host site 6 and choose a member's 16 database where the information they are requesting is located. Once the consumer 10 selects the desired database, the consumer 10 is able to view and select information that they would like to extract. Upon the selection of the information by the consumer 10, the host site 6 would compile the information along with any unsolicited information found by the host site 6 and display it for the consumer 10 as disclosed in the preferred embodiment.

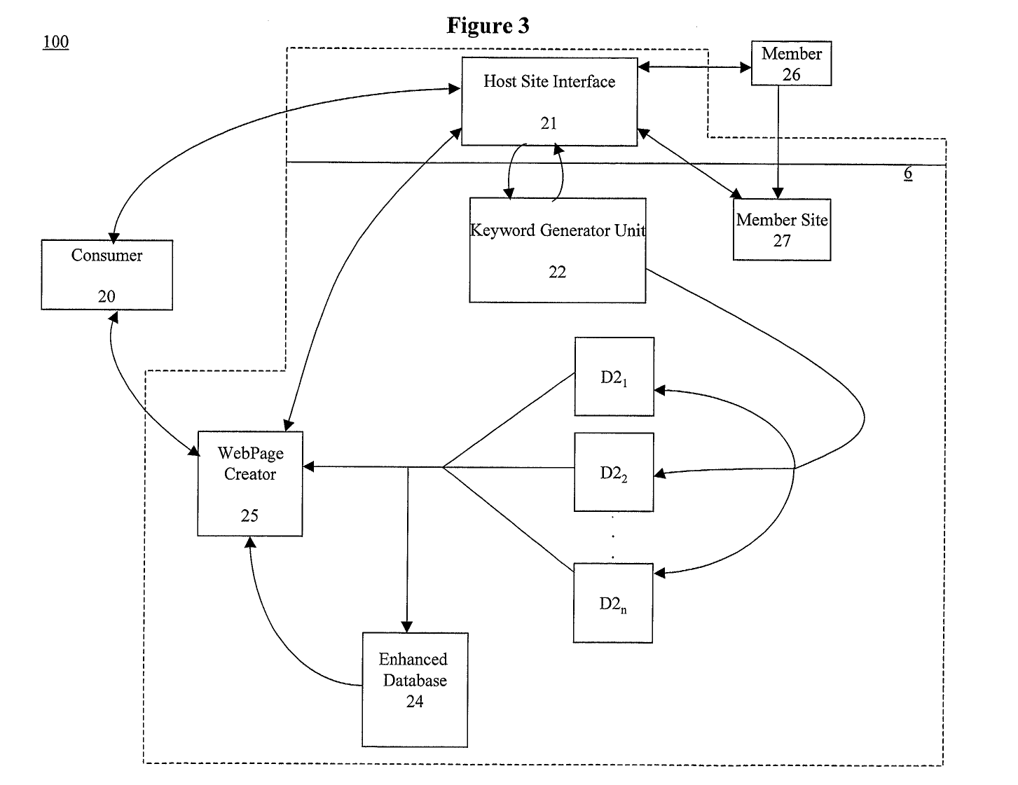

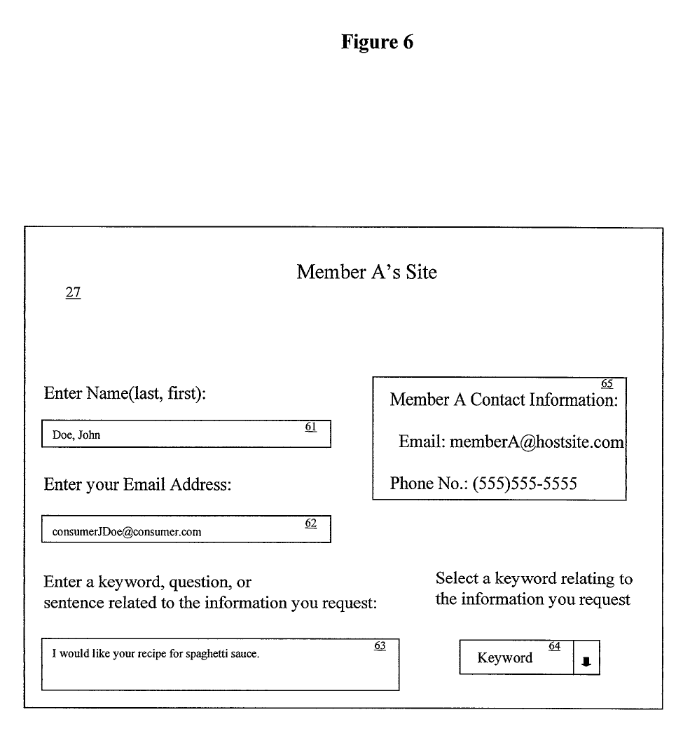

A third alternative embodiment of the present invention is shown in FIG. 3. This information distribution system 100 has included therewith, along with the other components described in the previous embodiments, a keyword generator unit 22. The host site interface 21 provides an interface for both the member 26 and the consumer 20. As with the prior embodiments, the member 26 interfaces with the host site 6 through the host site interface 21 to manipulate and update their information as well as to request the host site 6 to conduct a search and distribute operation. However, this embodiment allows the consumer 20 to interface with the host site 6 as well. The consumer 20 is able to request data directly from a member's site 27. Those consumers 20 who know that an individual is a member of the host site 6 and know the member's 26 registered name can request specific information from the member 26 through the host site interface 21. A member site 27 is provided for each registered member of the host site 6. This site contains the member's contact information 65 and a request form that allows the consumer 20 to solicit information online, (see FIG. 6).

Referring to FIG. 6, the host site 6 provides two methods for a consumer 20 to request information directly through the member site 27. One method is through the use of a word or phrase 64 located on the member site 27 that, when selected by the consumer 20, uploads the word or phrase directly to the databases D2₁, D2₂. . . D2ₙ.

A second method for a consumer to request information directly is for the consumer 20 to enter the information that they request from the member site 27. The consumer 20 is prompted to enter their name 61, e-mail address 62 and a request 63, question, keyword or sentence that relates to the solicited information they desire. The request 63 from the consumer 20 in the space provided on the member site 27 is uploaded to the keyword generating unit 22.

Returning to FIG. 3, the keyword generating unit 22 analyzes the information that is uploaded from the host site interface 21 and develops specific keywords to be utilized by the databases D2₁, D2₂. . . D2ₙ. The keyword generating unit 22, coupled to the host site interface 21 and the databases D2₁, D2₂. . . D2ₙ, receives the output of the member site 27 and determines the specific keywords to be output to the databases D2₁, D2₂. . . D2ₙ. When the output of the member site 27 is generated by the consumer 20 selecting a specific word or phrase, the selection is passed on to the databases D2₁, D2₂. . . D2ₙ, as disclosed in the previous embodiment. If the output is not generated in this way, the keyword generator unit 22 analyzes the output and associates a keyword(s) with the request. The keyword generator unit 22 passes the output from the member site 27 to the databases D2₁, D2₂. . . D2ₙ. If the output from the member site 27 is a sentence, or question from the consumer 20, it is analyzed in order to generate at least one keyword from the sentence or question. As those skilled in the art should know, there are multiple methods of generating a keyword from a phrase, such as the parsing of a phrase that is performed by current search engines. These methods may produce many keywords, very broad requests or one keyword from a very specific request. If a keyword cannot be generated from the input by the consumer 20, a signal is output to the host site 6 which will output a message through the host site interface 21 setting forth this error.

Once a keyword(s) is generated from the sentence request, the keyword generator unit 22 outputs them to the databases D2₁, D2₂. . . D2ₙ. The remaining components of this embodiment are equivalent to those disclosed in the preferred embodiment.

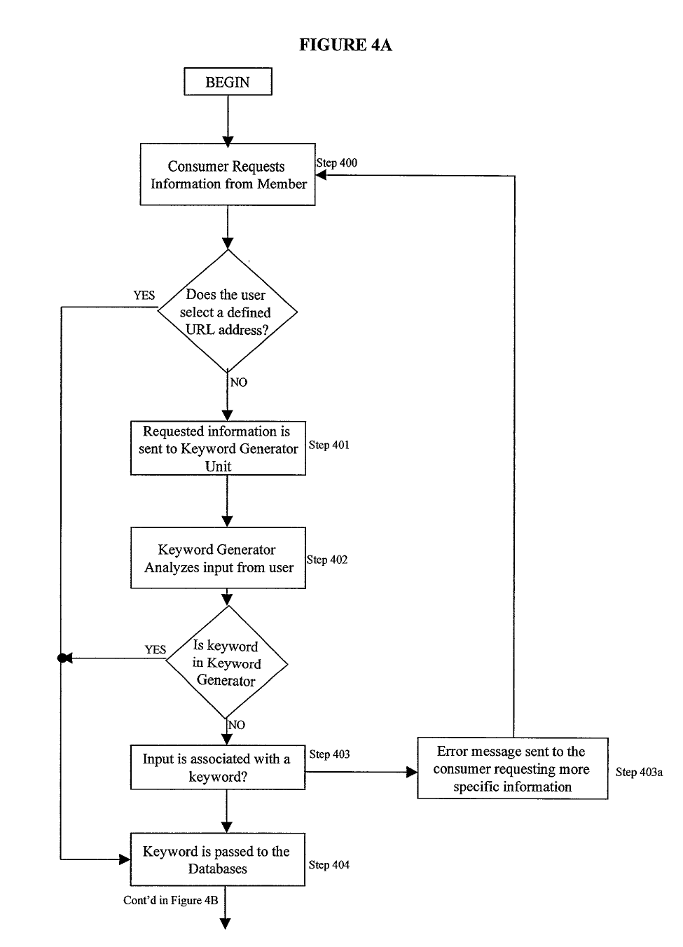

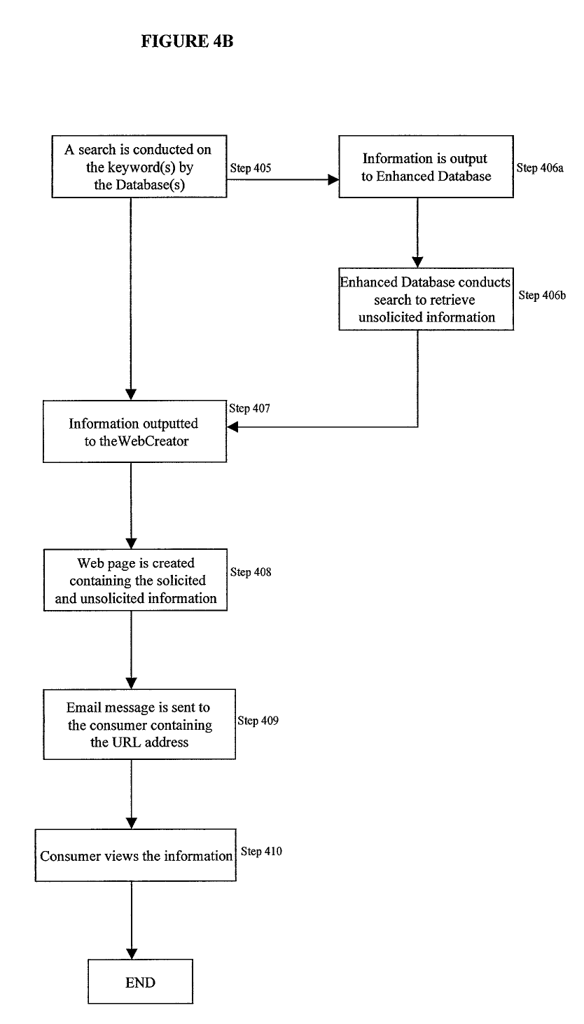

The tasks of the information system in this second alternative embodiment are illustrated in FIGS. 4A and 4B. The consumer 20 requests information regarding a specific topic (step 400). If the consumer 20 chooses to select a predefined word or phrase on the member request page, the requested information is sent to the databases D2₁, D2₂. . . D2ₙ (step 404). If the consumer 20 chooses to type in a request, the requested information is sent to the keyword generator unit 22 (step 401). The keyword generator unit 22 analyzes the input from the consumer 20 (step 402). If the input from the consumer 20 is a simple keyword, it is passed directly to the databases D2₁, D2₂. . . D2ₙ, (step 404). Otherwise, the input is analyzed and associated with a keyword stored in the keyword generator unit 22 (step 403) and output to the databases D2₁, D2₂. . . D2ₙ (step 404). If a keyword cannot be associated with the requested information, an error message is sent to the consumer 20 setting forth the above error (step 403a). Each database D2₁, D2₂. . . D2ₙ receives the keyword and conducts a search on the information stored in their respective information databases (step 405), and outputs the found information to the webpage creator unit 25 (step 407) and the enhanced database 24 (step 406a). Upon receipt of the retrieved information, the enhanced database 24 conducts a search of its database (step 406b) for any related information. The found unsolicited information is also sent to the webpage creator unit 25 (step 407). The webpage creator unit 25 then creates a webpage containing the solicited information as well as the unsolicited information from the database(s) D2₁, D2₂. . . D2ₙ and the enhanced database 24 (step 408). An e-mail message is then sent to the consumer 20 containing a URL (step 409), that allows the consumer 20 to click thereon and view the information provided (step 410).

Although the invention has been described in part by making detailed reference to the preferred embodiment, such details intended to be instructive rather than restrictive. It will be appreciated by those skilled in the art that many variations may be made in the structure and mode of operation without departing from the spirit and scope of the invention as disclosed in the teachings herein.

What is claimed is:

1. An information system for selectively providing information in response to a request from a user, the information system comprising:
a first memory, for storing a first database of information;
a second memory, for storing a second database of information;
a first search unit, for analyzing said request and retrieving information related to said request from said first memory to generate a first output information signal;
a second search unit, for analyzing said first output information signal and retrieving information related to said first output information signal from said second memory to generate a second output information signal;
a webpage unit for receiving said first and second output information signals and selectively displaying said signals on a webpage; and
an output unit, for generating an e-mail to said user which includes the address of said webpage.

2. The information system of claim 1 further including a security system for permitting limited access to said information system upon the receipt of an access code; wherein said e-mail further includes said access code for permitting access to said webpage by said user.

3. The information system of claim 1 whereby said first and second memories are portions of a single memory.

4. The information system of claim 1 whereby said first and second search units comprise a single search unit.

5. A method for selectively providing information in response to a request from a user, the method comprising the steps of:
receiving said request from said user;
analyzing said request;
retrieving first information from a first database in response to said analysis of said request;
generating a first output information signal;
analyzing said first output information signal;
retrieving second information from a second database in response to said analysis of said first output information signal;
generating a second output information signal;
generating a selective display on a webpage of said first and second output signals; and
sending access information to said user to permit viewing of said selective display by said user.

6. The method of claim 5, wherein said access information comprises:
a URL to locate the webpage; and
an access code to permit viewing of said selective display by said user.

7. The method of claim 6, whereby said first database is remotely located from said second database.

8. An information system for selectively providing information in response to a request from a user, the system comprising:
a remote memory, located remotely from said information system for storing a first database of information, including at least a portion of information related to said request;
first memory, for storing a second database of information;
a link unit for retrieving said portion of information related to said request said remote memory and generating a first output information signal;
a first search unit, for analyzing said first output information signal, retrieving information related to said first output information signal, and generating a second output information signal;
a webpage unit for receiving said first and second output information signals and selectively displaying said signals on a webpage; and
an output unit for generating an e-mail to said user including the address of said webpage.

9. The system of claim 8 wherein said e-mail further includes an access code for selectively permitting access to said webpage by said user.

10. A system for selectively providing information in response to a request from a user, the system comprising:
a first memory, for storing a first database of information;
a second memory, for storing a second database of information;
a user connection, for providing said user access to said first database of information, wherein said user makes said request and generates a first output information signal;
a first search unit, for analyzing said first output information signal and retrieving information related to said first output information signal from said second memory to generate a second output information signal;
a webpage unit for receiving said first and second output information signals and selectively displaying said signals on a webpage; and
an output unit, for generating an e-mail to said user which includes the address of said webpage.

11. The information system of claim 10 further including a security system for permitting limited access to said information system upon the receipt of an access code; wherein said e-mail further includes said access code for permitting access to said webpage by said user.

12. A method for selectively providing information in response to a request from a user, the method comprising:
receiving a request from said user;
generating a first output information signal;
analyzing said first output information signal;
retrieving second information response to said analysis of said first output information signal;
generating a second output information signal;
generating a display of said first and second output information signals; and
sending access information to said user to permit viewing of said display.

13. The method of claim 12 wherein the access information comprises;
a URL to locate the webpage, and an access code to permit viewing of said display by said user.

14. A system for selectively providing information in response to a request from a user, the system comprising:
a memory, for storing first and second databases of information;
a search unit, for analyzing said request and retrieving information related to said request information said first database to generate first output information signal; and for analyzing said first output information signal and retrieving information related to said first output information signal from said second database to generate a second output information signal;
a webpage unit for receiving said first and second output information signals and selectively displaying said signals on a webpage; and
an output unit, for generating an e-mail to said user, the e-mail including the web address of said webpage.

15. The system of claim 14 wherein said web address further includes an access code for permitting access to said webpage to said user.
